(19) United States
(12) Patent Application Publication
(10) Pub. No.: US 2023/0415911 A1
(43) Pub. Date: Dec. 28, 2023

(54) MAXIMUM PERFORMANCE AVIATION INSTRUMENT FOR ENGINE FAILURE OPERATION OF AIRCRAFT

(71) Applicant: William E. Lawson, Somerset, WI (US)

(72) Inventor: William E. Lawson, Somerset, WI (US)

(21) Appl. No.: 18/126,939

(22) Filed: Mar. 27, 2023

Related U.S. Application Data
(60) Provisional application No. 63/355,081, filed on Jun. 23, 2022.

(51) Int. Cl. B64D 43/00

(52) U.S. Cl. CPC B64D 43/00; B64C 13/044

(57) ABSTRACT

A maximum performance instrument for an aircraft is configured to aid a pilot in taking corrective action, after loss of functionality of one of the aircraft engines, in order to maintain as much control of the aircraft as possible. The information is provided to the pilot on a single instrument display in a format that is familiar to most pilots so that the information is immediately usable by the pilot without a high degree of proficiency or training with the instrument.

### CROSS-REFERENCE TO RELATED APPLICATION(S)

This application claims the benefit of U.S. provisional application No. 63/355,081, filed on Jun. 23, 2022, the content of which is hereby incorporated by reference in its entirety.

### BACKGROUND

The present disclosure is directed toward aviation instruments for use by a pilot in flying an aircraft. More particularly, the present disclosure is directed to an aviation instrument which provides maximum performance information in the event of an engine failure in a twin engine aircraft.

In twin engine aircraft, after an emergency situation involving failure of one engine, controlling the unbalanced aircraft can be difficult as several separate indications in different formats and locations need to be recognized and then analyzed relative to each other and then acted on to successfully control the aircraft. Gaining control of the aircraft must occur rapidly as a Vmc. (minimum controllable airspeed) rollover can happen within 10 seconds under some circumstances, for example just after takeoff, due to the reduced and asymmetric thrust. If speed drops below this airspeed, the plane will start to increase the yaw away from the live engine, to the point where eventually the outer wing produces more lift than the inner wing and the aircraft rolls over.

In order to prevent a Vmc rollover in the event of engine failure, in a conventional aircraft this requires the pilot to use several different indications from several different instruments to fly the aircraft successfully. The pilot must determine which way the aircraft is yawing and try to counteract it with rudder. The pilot will attempt to pitch the aircraft so it flies at a predetermined speed indicated on the airspeed indicator, usually the “blue line” (typically Vyse—velocity max climb rate single engine). Factors such as gear up, gear down, the amount of flap deflection, the aircraft center of gravity, and how heavy the aircraft is all affect the optimum speed. The pilot must also identify the failed engine and bank the aircraft into the good engine by some amount that helps counteract the yaw and reduce drag. All of these actions, and others, must be performed while the pilot also works to clean up the aircraft by reducing the drag and potentially working to correct the problem (e.g., empty fuel tank) which can require a number of different additional actions depending on the situation.

To implement these emergency actions, the pilot must take indications from several different instruments and combine their indications to get the desired speed needed to watch the airspeed carefully and keep it at the blue line, while putting in the correct amount of rudder in the correct direction and establishing the necessary bank angle into the good engine. At the same time the pilot needs to take actions to reduce the drag of the failed engine, and of other components such as the flaps and the gear. Also, at the same time the pilot will be attempting to determine which engine has experienced failure and to try to regain function of that engine (e.g., by switching fuel tanks, turning on an auxiliary fuel pump for that engine, verifying and feathering the engine, etc.). All these tasks are huge distractions from flying the aircraft, resulting in reduced situational awareness.

The discussion above is merely provided for general background information and is not intended to be used as an aid in determining the scope of the claimed subject matter.

### SUMMARY

This Summary and the Abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

Disclosed embodiments include single aviation instruments configured to aid a pilot in maximizing performance of the aircraft after loss of functionality of one of the aircraft engines. The disclosed maximum performance instruments are configured to display the information necessary for the pilot to optimally act to address the loss of engine situation and maintain control of the aircraft. The information is provided to the pilot on a single instrument display in a format that is already familiar to most pilots so that the information is immediately usable by the pilot without a high degree of proficiency or training with the instrument.

In a first exemplary embodiment, an aviation instrument is provided for use by a pilot of an aircraft in the event of loss or reduction of functionality of an engine of the aircraft. The aviation instrument comprising a display device; and processing circuitry coupled to the display device. The processing circuitry is configured to control the display device to display a performance indication graphic which indicates to the pilot corrective action needed to control the aircraft to counteract adverse yaw motion caused by the event of loss or reduction of functionality of the engine of the aircraft.

In some more particular embodiments, the processing circuitry is further configured to control the display device to indicate to the pilot of the aircraft an optimum angle of attack for the aircraft, responsive to the event of loss or reduction of functionality of the engine of the aircraft. The optimum angle of attack for the aircraft indicated by the display device can be an angle of attack determined to provide a maximum climb or a minimum sink to optimize performance of the aircraft.

In some more particular embodiments, the processing circuitry is configured to automatically activate the aviation instrument upon sensing of excessive yaw motion of the aircraft.

In some more particular embodiments, the processing circuitry is configured to control the display device to display the performance indication graphic to indicate to the pilot which direction a rudder of the aircraft should be deflected to counteract the adverse yaw. In some embodiments, the performance indication graphic indicates to the pilot an amount of rudder deflection required to counteract the adverse yaw. In some embodiments, the performance indication graphic is a performance indication bar extending between left and right sides of the display device. In some embodiments, an orientation of the performance indication bar is indicative of an actual level horizon. In some embodiments, the display device is controlled by the processing circuitry such that the performance indication bar includes a thicker portion on one of the left and right sides of the display relative to the other of the left and right sides of the display to indicate which direction the rudder of the aircraft should be deflected to counteract the adverse yaw. The processing circuitry is configured in some embodiments to control the display device such that a length of the thicker portion of the performance indication bar is indicative of the amount of rudder deflection required to counteract the adverse yaw.

In some embodiments, the processing circuitry is further configured to control the display device to display an aircraft representation with the performance indication bar, and the processing circuitry is further configured to control the display device to display the aircraft representation and the performance indication bar such that an orientation of the performance indication bar relative to the aircraft representation indicates to the pilot a required bank angle of the aircraft in a direction of a non-failed engine.

In some embodiments, the processing circuitry is further configured to control the display device to display an artificial horizon line relative to the aircraft representation and the performance indication bar.

In some embodiments, the display device is controlled by the processing circuitry to include a left side indicator and a ride side indicator, and the processing circuitry is configured to control the display device to illuminate one of the left-side indicator and the right-side indicator to indicate to the pilot which direction the rudder of the aircraft should be deflected to counteract the adverse yaw.

In another exemplary embodiment, an aviation instrument is provided for use by a pilot of an aircraft in the event of loss or reduction of functionality of an engine of the aircraft, the aircraft including a rudder controlled by left and right rudder pedals, the aircraft also including flaps controlled by a flap control device. The aviation instrument comprising a display device and processing circuitry coupled to the display device. The processing circuitry is configured to control the display device to display a performance indication graphic which indicates to the pilot corrective action needed to control the aircraft to counteract adverse yaw motion of the aircraft caused by the event of the loss or reduction of functionality of the engine, the corrective action indicated by the performance indication graphic including an indication of which of the left and right rudder pedals should be deflected to deflect the rudder and thereby counteract the adverse yaw motion of the aircraft, and the processing circuitry is further configured to control the display device to indicate to the pilot of the aircraft an optimum angle of attack for the aircraft, responsive to the event of loss or reduction of functionality of the engine of the aircraft.

In some exemplary embodiments, the processing circuitry is further configured to control the display device to indicate to the pilot an optimum direction and angle of bank of the aircraft, responsive to the event of loss or reduction of functionality of the engine of the aircraft.

In some exemplary embodiments, the performance indication graphic is a performance indication bar extending between left and right sides of the display device, and wherein an orientation of the performance indication bar is indicative of an actual level horizon, wherein the display device is controlled by the processing circuitry such that the performance indication bar includes a thicker portion on one of the left and right sides of the display device relative to the other of the left and right sides of the display device to indicate which of the left and right rudder pedals should be deflected to deflect the rudder and thereby counteract the adverse yaw motion of the aircraft, and wherein the display device is controlled by the processing circuitry such that a length of the thicker portion of the performance indication bar is indicative of the amount of rudder pedal deflection required to deflect the rudder to counteract the adverse yaw motion of the aircraft.

In some exemplary embodiments, the processing circuitry is further configured to control the display device to display an aircraft representation with the performance indication bar, and the processing circuitry is configured to control the display device to display the aircraft representation and the performance indication bar such that an orientation of the performance indication bar relative to the aircraft representation indicates to the pilot a required bank angle of the aircraft in a direction of a non-failed engine.

In some embodiments, the processing circuitry is further configured to control the display device to display an artificial horizon line relative to the aircraft representation and the performance indication bar.

In some embodiments, the display device includes a left-side indicator and a right-side indicator, and the processing circuitry is configured to control the display device to illuminate one of the left-side indicator and the right-side indicator to further indicate to the pilot which of the left and right rudder pedals should be deflected to deflect the rudder and thereby counteract the adverse yaw motion of the aircraft

### BRIEF DESCRIPTION OF THE DRAWINGS

FIG. 1 is a diagrammatic illustration of an aircraft, defining the pitch, roll and yaw axis.

FIG. 2 is a block diagram illustration of a maximum performance instrument for use by a pilot in the event of loss of functionality of an engine in accordance with some disclosed embodiments.

FIGS. 3-5 are diagrammatic illustrations of a display format for first embodiments of the maximum performance instrument of FIG. 2.

FIGS. 6-7 are diagrammatic illustrations of a display format for second embodiments of the maximum performance instrument of FIG. 2.

### DETAILED DESCRIPTION

The concepts disclosed in this discussion are described and illustrated with reference to exemplary or illustrative embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Disclosed embodiments are directed to an aviation instrument configured to aid a pilot in maximizing performance of the aircraft after loss or reduction of functionality of one of the aircraft engines. The proposed solution is to display the information necessary for the pilot to optimally act to address the situation and maintain control of the aircraft. The information is provided to the pilot on a single instrument display in a format that is already familiar to most pilots so that the information is immediately usable by the pilot without a high degree of proficiency or training with the instrument. A significant problem the disclosed instrument and system are designed to address is that an engine loss situation is uncommon and even if the pilot trains regularly on what to do in this situation it is very difficult with conventional avionics equipment for the pilot to switch instantly from flying the aircraft under normal conditions to flying the aircraft with a failed engine while interpreting several pieces of information, displayed on several different instruments and not frequently interpreted together in normal operation, to keep the aircraft under control. If remedial action is not taken immediately, loss of an engine can result in a very unbalanced aircraft and many times results in a Vmc rollover due to the reduced thrust coupled with the asymmetric thrust. A Vmc rollover can happen in 10 seconds or less, especially in situations occurring in conditions just after takeoff.

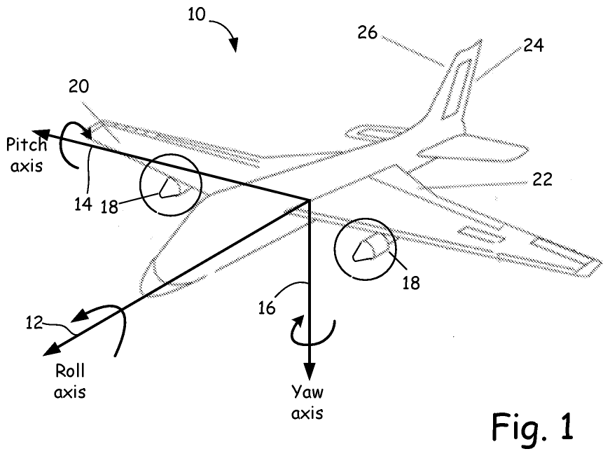

Referring now to FIG. 1, shown is an aircraft 10 and a coordinate system showing a roll axis 12, a pitch axis 14 and a yaw axis 16. Aircraft 10 is shown having twin engines 18 disposed on opposite side wings 20. Flaps 22 are positioned on the wings to allow the pilot to control lift and drag of the aircraft. A rudder 24 on the vertical stabilizer allows the pilot to change the yaw or side-to-side motion of the aircraft. As discussed, loss of functionality of one of engines 18 will typically cause a number of things to occur which make flying the aircraft difficult, and which can compound into a Vmc rollover situation. Due to the imbalanced thrust between sides of the aircraft, the aircraft will begin to yaw (rotate about axis 16) and will frequently slow down.

In order to prevent a Vmc rollover in the event of engine failure, the pilot must determine which way the aircraft is yawing and try to counteract it with deflection of the rudder 24 through actuation of the correct rudder pedal. The pilot attempts to bank the aircraft into the good engine by some amount that helps counteract the yaw and reduce drag. The pilot will also attempt to pitch the aircraft, using a control wheel, yoke, stick or other pilot control device, so that the aircraft flies at a predetermined speed indicated on the airspeed indicator, e.g., commonly the “blue line” speed. The goal for maximum performance is to control the aircraft so it is flying at the optimum Angle of Attack (AOA) and zero sideslip or yaw. If the aircraft has excess power, the pilot will attempt to control it to climb or fly faster thus allowing some safety factor or, if not enough power is available to climb or stay level, the pilot will attempt to achieve minimum sink of the aircraft. It has been proven that even in an aircraft that does not have enough power to stay level, keeping it flying with minimum sink allows time to try to find a good location to put it down. An aircraft that is in controlled flight when it crashes has a much higher chance of the occupants surviving the crash.

In order to improve a pilot's situational awareness in the event of loss of an engine, and the ability to quickly assess what corrective actions must be taken, disclosed embodiments provide an aircraft instrument that combines the various relevant information from multiple other instruments or sources into a format that the pilot can readily interpret. Disclosed instruments are similar in functionality and appearance to traditional artificial horizon instruments, or attitude indicators, which pilots use extensively. Thus, the disclosed instruments can be quickly interpreted by a pilot as compared to an instrument for engine failure operation that might have a new format, seldom used in normal flying, that the pilot may have trained for but uses very infrequently. Thus, using a display format that the pilot instinctively knows how to use in normal aircraft operation will reduce the confusion dramatically and increase the chances of things going well.

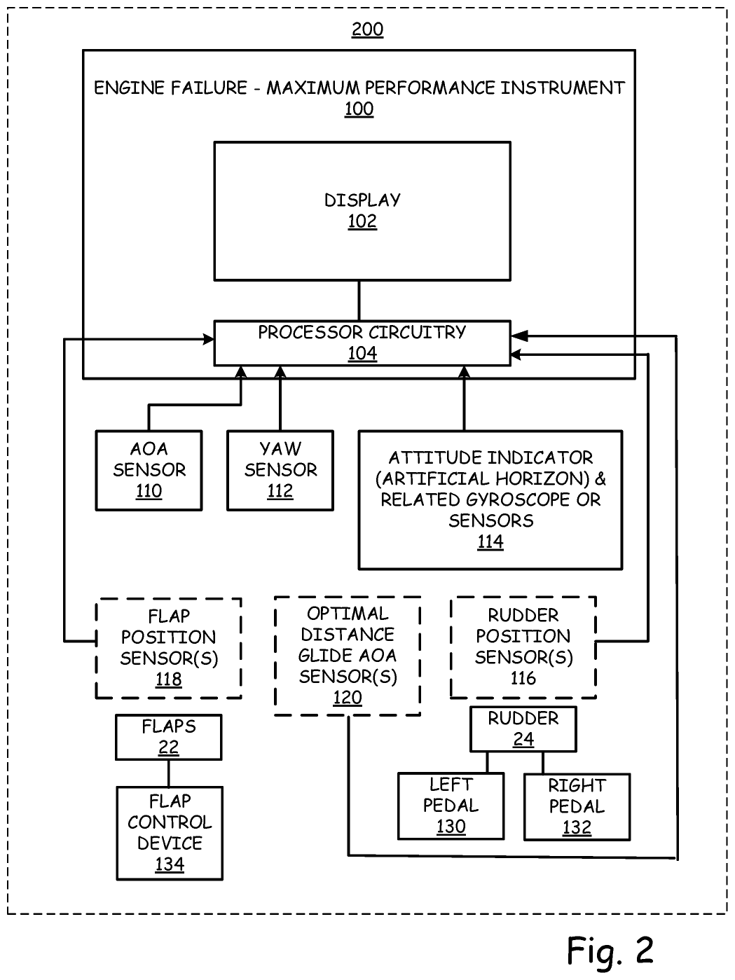

Referring now to FIG. 2, shown is aviation instrument 100 in accordance with exemplary embodiments, shown diagrammatically installed on an aircraft 200. Only select components of aircraft 200 are illustrated in FIG. 2. Instrument 100 is engine failure maximum performance instrument which provides vital information to the pilot in a format which is familiar to the pilot, and which allows the pilot to control the aircraft in the engine failure scenario without accessing multiple different instruments or screens. This greatly improves the pilot's ability to react quickly and thereby improves the likelihood that the pilot will maintain control of the aircraft. Instrument 100 provides information to the pilot to command the maximum performance possible for the aircraft in any situation and configuration after loss of functionality of an engine, whether it results in a climb or a minimum sink.

Instrument 100 includes a display 102 providing a display of information for viewing by the pilot, and processing circuitry 104 coupled to the display and configured to generate display control signals to control the display of information based upon inputs received from sensors and systems. A first input to instrument 100 is an angle of attack (AOA) sensor or system 110 which detects or measures the angle of attack of the aircraft and provides this information to processing circuitry 104. A second input to instrument 100 is a yaw sensor or system 112 which detects or measures the yaw or slip angle of the aircraft and provides this information to the processing circuitry. Another input to instrument 100 is an attitude indicator (AI) 114, or artificial horizon device, and/or associated gyroscopes and sensors. The attitude indicator 114 provides pitch and roll information to determine a desired bank angle of the aircraft during the engine failure operation.

In some exemplary embodiments, one or more rudder position sensors 116 can optionally be utilized in a system to provide instrument 100 an indication of a detected or measured deflection amount or position of rudder 24. As rudder 24 is controlled by left rudder pedal 130 and right rudder pedal 132, position sensor(s) 116 can in some embodiments measure deflection of the rudder pedals if desired. In either case, rudder position sensors 116 can be useful in preventing the system from reducing the required bank angle at zero yaw. Further, in some exemplary embodiments, one or more flap position sensors 118, which measure the deflection of flaps 22 on the aircraft responsive to flap pilot control device 134, can also be utilized in a system to provide flap deflection information to instrument 100 if it has an effect on the optimal angle of attack of the aircraft. As the flap position may change the optimum angle of attack, use of flap position sensor 118 to detect the flap position allows the processing circuitry to modify the commanded angle of attack to an optimal angle of attack for the detected flap position. Further still, in some embodiments, switches 120 configured to command the best distance glide AOA can provide input to instrument 100 for the situation where correcting with rudder and banking into the good engine does not result in level flight or a climb, as the blue line may not be optimum for longest distance traveled in case of a negative climb.

In various example embodiments described further below, instrument 100 is configured to generate, on display device 102, an instrument format that looks and performs very similarly to the artificial horizon on an attitude indication, which every pilot uses as his primary flight instrument conventionally, with the pitch command controlled responsive to an angle of attack or similar detector to command the most efficient pitch to fly the aircraft at, independent factors such as weight drag, etc. The instrument includes maximum performance indication which identifies to the pilot which engine has failed, how much pitch is required, how much bank is required and which rudder foot pedal should be pushed to achieve the bank, among other information.

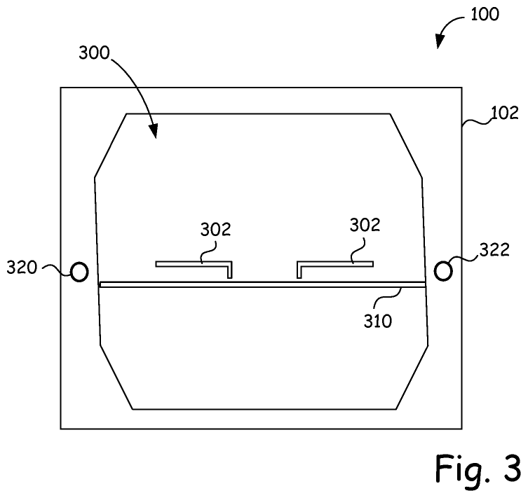

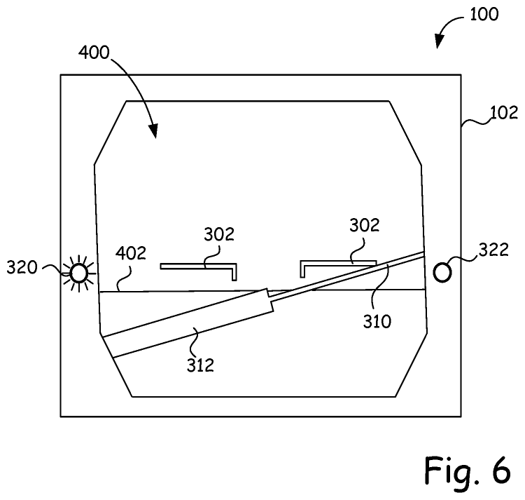

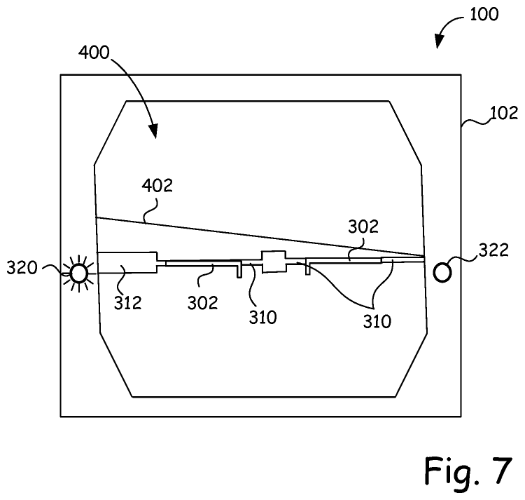

The display format of the disclosed instruments can include the artificial horizon in some embodiments (e.g., as discussed with reference to FIGS. 6-7), but does not require the artificial horizon to be displayed in other embodiments (e.g., as discussed with reference to FIGS. 3-5). The processing circuitry is configured to control the display device to display a performance indication graphic which indicates to the pilot corrective action needed to control the aircraft to counteract adverse yaw motion caused by the event of loss or reduction of functionality of the engine of the aircraft. Such a maximum performance indication, for example in the form of a maximum performance line, can be controlled as a function of a conventional artificial horizon roll command, plus any additional roll commanded by the yaw sensor or detector 112 to command a bank, for example a five-degree bank (standard requirement for certification), into the good engine relative to the actual horizon. Depending on the situation, instrument 100 can also command even more additional roll, or if no additional roll is needed to counteract yaw (e.g., if use of the rudder was sufficient to counteract the adverse yaw). In exemplary embodiments, the maximum performance indication can be a horizontal bar which shows the actual level horizon. It is noted that there usually is one angle of attack that for most efficient flight of a particular aircraft (i.e., produces the lowest drag at this angle of attack), independent of weight, etc. Thus, this particular angle of attack for the aircraft in which instrument 100 is installed is a constant characteristic independent of configuration and the aircraft will have the best chance of successfully continuing to fly if the aircraft is kept at this optimum AOA parameter. Again, in some embodiments, the processing circuitry is configured to modify the angle of attack based upon the aircraft flap position as detected by flap position sensor 118.

Further, in the instrument display formats and configuration embodiments discussed below, in order to best inform the pilot how to counteract adverse yaw motion of the aircraft with the rudder, a non-ambiguous indication is provided to the pilot to show which way the rudder should be deflected and by how much. In various aircraft designs, either full or partial rudder defection may be necessary. For example, in some embodiments, the background or other significant portions of the display, such as the horizon bar, on one side of the display or the other is controlled to turn red (or other color) to indicate which rudder pedal to push to counteract the yaw. For example, using the “rule” of stepping on the red side, similar to the rule for reducing yaw with the inclinometer turn and bank instrument that indicates when the aircraft is coordinated, with the red decreasing as the yaw is eliminated. In some embodiments, when the yaw is completely eliminated the commanded extra bank angle correction is decrease appropriately. Further, in some embodiments, application of too much rudder causes the other side of the display to start turning red (or other selected color). Also, if more roll than the standard maximum 5 deg is acceptable for the aircraft and situation, the additional roll can be added in the correct direction for the particular aircraft if allowed by certifying authorities.

Referring now to FIGS. 3-5, shown is first embodiment of the display configuration of instrument 100 which can be used to guide the pilot to the most efficient control steps for the aircraft in the event of loss of functionality of one of its engines. As is the case in conventional attitude indicators, display configuration 300 provided on display 102 includes an aircraft representation 302. However, instead of including an artificial horizon, display configuration 300 includes a maximum performance indicator or indicator bar 310 which is configurable to provide representative information to the pilot on engine failure and actions that should be taken to counteract yaw movement of the aircraft, implement a desired bank angle into the remaining functional engine, changing the pitch to an optimal angle of attack, etc. The performance indicating bar is one embodiment of a performance indication graphic which indicates to the pilot corrective action needed to control the aircraft in the event of loss or reduction of functionality of the engine of the aircraft. However, other performance indicating graphics can also be used in exemplary embodiments. Further, in some embodiments, display 102 optionally includes light emitting diodes (LEDs) or other bright indicator spots, icons, widgets, etc., all referred to as indicators 320 and 322, positioned on left and right sides of the display screen to provide an immediate indication to the pilot of which rudder pedal to press to take corrective action. With some displays having only a solid-state screen and no other devices, the indicators 320 and 322 for which rudder pedal to push can be an area of the screen showing the necessary indication. Generally, failure of an engine on one side of the aircraft will cause the aircraft to yaw toward the failed engine side, and the pilot will need to control the rudder to correct this yaw.

FIG. 3 illustrates display configuration 300 in a scenario with a normal aircraft takeoff and both engines operating such that the aircraft is experiencing no yaw. The angle of attack is less than the aircrafts best angle of attack as the power allows the aircraft to operate at a lower angle of attack for a faster airspeed.

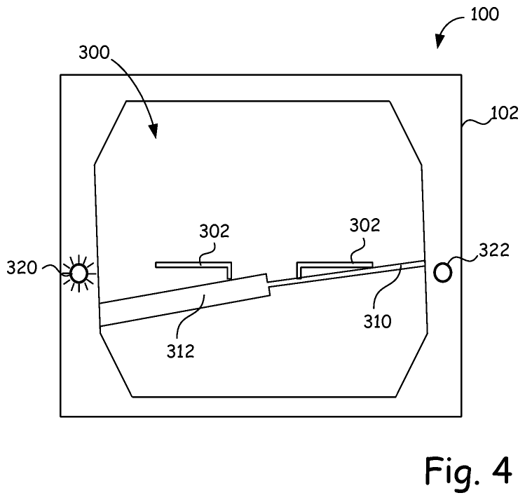

FIG. 4 illustrates display configuration 300 in a scenario where the right engine has failed or has reduced thrust and a yaw has developed, but no corrective action has been taken by the pilot. As the rudder has not been deflected as desired and the angle of attack is too high, a stall, Vmc rollover is imminent. To indicate to the pilot which rudder pedal to push to deflect the rudder in the direction necessary to counteract the yaw, maximum performance indicator bar 310 now has a thicker or wider section 312 on the left of the display. This informs the pilot that the left rudder pedal must be pushed to take the corrective action. The length of the thicker or wider section 312 is indicative of how much additional rudder deflection is required, with a longer wide section 312 indicating that more additional deflection is required as compared to when a shorter wide section is displayed. Note that in some embodiments, the indicator 320 or 322 on the side of the display corresponding to the rudder pedal which must be pushed lights up to provide additional or alternative representation to the pilot. In the scenario illustrated in FIG. 4, left-side indicator 320 is illuminating to indicate that the left rudder pedal must be pushed. The orientation of the indicator bar 310 relative to the aircraft representation 302, with the indicator bar rotated at an angle relative to the aircraft representation, shows that the angle of attack is too high and that bank into the functioning left engine is required.

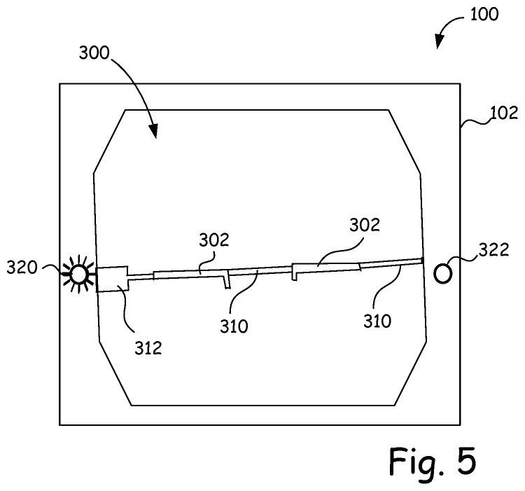

FIG. 5 illustrates display configuration 300 in a scenario where the pilot has responded to the information represented in the display configuration shown in FIG. 4 by pressing the left rudder pedal and banking the aircraft into the good (i.e., left) engine such that the aircraft is flying at maximum possible performance given the failed engine and current aircraft conditions. To indicate that the appropriate bank angle into the functioning engine has been achieved, the orientation of the aircraft representation 302 and the orientation of the maximum performance indicator bar 310 are displayed in alignment angularly or rotationally as the aircraft and instrument are banked the correct amount to the left.

As the rudder pedal is almost fully actuated, the wide section 312 of maximum performance indicator bar 310 has shortened toward the left side of the display to reflect this fact and to represent the amount of additional rudder pedal action available. Note that in further embodiments, the wide section 312 of maximum performance indicator bar 310 can be configured to shorten toward the center of the display (e.g., toward the aircraft representation 302) as the rudder pedal is pushed, instead of shortening toward the side as illustrated in FIG. 5 relative to FIG. 4. Again, as the left rudder pedal is commanded to be pressed for maximum performance of the aircraft, left side indicator 320 can be illuminated to help the pilot rapidly recognize this fact.

While in some embodiments, such as those discussed in FIGS. 3-5, instrument 100 is configured such that the display configuration of display 102 shows the maximum performance indicator bar instead of an artificial horizon, in other embodiments, the display configuration shows the maximum performance indicator bar in conjunction with the artificial horizon of a conventional attitude indicator instrument. Such an alternate display configuration 400 is illustrated in the example embodiment shown in FIGS. 6-7, where an artificial horizon line 402 is also included in the displayed information. The artificial horizon line 402 is a representation of conventional artificial horizon formats where the display is blue above the horizon line, and brown below the horizon line. However, other formats can be used as well.

FIG. 6 illustrates display configuration 400 in a scenario where the right engine of the aircraft has failed. The aircraft representation 302 relative to the artificial horizon line 402 shows that the aircraft is nose high, angle of attack high, with no bank. With wide section 312 of maximum performance indicator bar 310 extending all of the way to the center (left to right) of the display, the pilot can see that no rudder deflection has been initiated and that the left-side rudder pedal should be actuated. In this scenario, yaw has developed and the aircraft is slowing down quickly due to the angle of attack being too high. With aircraft representation 302 being above the maximum performance indicator bar 310, and with the indicator bar 310/312 angled downwardly to the left relative to aircraft representation 302, instrument 100 is commanding the pilot to lower the nose of the aircraft, bank to the left, and step on the left rudder.

FIG. 7 illustrates display configuration 400 after corrective action has been taken by the pilot. With the aircraft representation 302 being aligned with the maximum performance indicator bar 310, the pilot can see that the angle of attack has been adjusted to the optimal angle of attack for this situation, and that the aircraft has achieved the commanded bank angle into the good (i.e., left in the scenario) engine. The aircraft representation 302 being below the artificial horizon line 402 shows the pilot that the aircraft is still descending. At this point, having taken necessary immediate corrective action, the pilot will take additional steps of identifying the failed engine and attempting to regain its functionality, for example by changing fuel tanks, turning on the fuel pump, feathering the prop, etc. If done properly, the drag should be reduced changing the optimum AOA for maximum performance and the aircraft nose can be raised to reduce the descent by following the AOA command, or if enough power is available, to establish a climb. The shorter wide section 312 of the indicator bar 310 indicates which rudder defection is commanded. However, in other embodiments this section 312 can be completely eliminated from the displayed information once the commanded amount of rudder deflection is achieved, and indicator 320 can be illuminated to convey the commanded rudder pedal to the pilot.

FIGS. 3-7 provide example display configuration embodiments for maximum performance instrument 100, but the present invention is not limited to these specific embodiments. Other configurations are possible to illustrate to the pilot, using a single instrument display, which rudder pedal to push and by how much, what aircraft bank and angle of attack adjustments must be made, etc., and these other display configurations are considered within the scope of some embodiments of the present invention. For example, instead of including a wide section 312 on maximum performance indicator bar 310, in other embodiments the optimal rudder pedal commands can be illustrated as separate vertical bars on the left and right sides of the display. Other variations are also contemplated. As a further example, while in addition to a longer length of the wide section of the maximum performance indicator bar indicating to the pilot that a large amount of rudder deflection is required on that side and a shorter or no length wide section indicating that the amount of rudder deflection is close to adequate, the bar can be configured such that too much rudder deflection is represented as well. This can be done for example by having the wide portion of the indicator bar appearing on the opposite side. Yet another example embodiment would add a vertical mark on the indicator bar on each side close to the end of the bar that would indicate zero yaw and the correct rudder displacement that would indicate the proper application of the rudder.

In the above discussions, the performance indicating graphic provides a differential indication on one of the left and right sides of the display relative to the other of the left and right sides of the display to indicate which direction the rudder of the aircraft should be deflected to counteract the adverse yaw. As discussed, this can be in the form of a performance indicator bar which is thicker on the side corresponding to the direction the rudder of the aircraft should be deflected. However, other differential indications can also be used. For example, wide section 312 can instead be a portion of a background of the display in a different color, the different colored portion changing area proportional to an amount of additional rudder required. For example, with a larger area of the different color indicating that a larger amount of additional rudder deflection is necessary to achieve the required rudder deflection, while a smaller area of the different color indicating that a smaller amount of additional rudder deflection is necessary to achieve the required rudder deflection.

As discussed, the single maximum performance instrument 100 allows the pilot to easily determine what is the most efficient combination of rudder and bank and command towards that combination. This will ideally result in the aircraft flying in the most efficient configuration to maintain flight. If excess power is available, these commands would result in a climb at optimum AOA (Angle of Attack), but even if there is insufficient power to maintain altitude, the commanded actions would result in the aircraft flying relatively straight with a minimum sink, giving the pilot more time to find a spot to put the aircraft down or allow other actions to be taken to reduce the drag while keeping the aircraft flying. After the aircraft is fully under control, then other actions would be added as necessary and the other instruments in the aircraft would be used as appropriate to continue the flight under control and improve performance.

In further exemplary embodiments, directional information can be included on the disclosed maximum performance instrument display configurations, similar to what is supplied by a directional Gyro. However, this information is not necessary to control the aircraft to achieve maximum performance, but could be very useful after the situation is stabilized. As the basic maximum performance instrument does not need directional information to deal with the immediate problem after loss of an engine, and such information could distract the pilot from the most urgent corrective actions, directional or other secondary information could be displayed only under certain circumstances. Further, in some embodiments, disclosed maximum performance instrument display configurations can include important messages. However, to maximize the pilot's situational awareness of the emergency actions that should first be taken, such messages should be kept to a minimum. In addition to displaying the heading information, in some embodiments a numbered arc that follows the heading of the aircraft (or other display format) can be displayed at the top of the instrument screen. A heading bug can be automatically set at the heading the aircraft is on at the time the instrument is activated by excessive yaw or activated by a manual button. This allows flying the aircraft without needing to look at the heading indicator, or in some aircraft, the Horizontal Situation Indicator (HSI), and taking the pilots attention off the maximum performance instrument. This bug can be set ahead of time or even slaved to the heading set in the instruments for take-off, with embodiments in which the bug is activated by excessive yaw being preferred modes of operation in some instrument designs. Further still, in some embodiments, the instrument displays an angle of attack where the climb rate is better if it can be achieved, especially after the pilot has corrected the aircraft functionality to some extent.

In some embodiments, the disclosed instruments can also indicate which engine is producing reduced thrust, but this indication would ideally need to be verified because overcompensating corrective actions, for example applying excess rudder, can cause yaw motion in the opposite direction and give a false indication for which engine is at reduced thrust.

In some embodiments, the disclosed instruments can be an alternate display on the glass panel of an aircraft, and can even be integrated into the Autopilot as an emergency command. As an example, in some embodiments the pilot can push a button or activate a switch to automatically take the corrective action identified by the disclosed maximum performance instruments. One example of this type of command is that some aircraft have commands. Where you can push a button and the aircraft will recover from an unusual attitude and fly straight and level. Further, in some embodiments, the disclosed maximum performance instrument can be configured such that the aircraft can be flown in the event of another type of emergency, for example loss of the primary artificial horizon instrument, with the proviso that the pitch commanded would be much higher than was actually needed to maintain level flight at speeds faster than optimum angle of attack. To do level flight would require the pilot to monitor the altitude and adjust the pitch accordingly. As another example of utility of some embodiments of the disclosed instruments, the instruments can be configured to be used for a conventional short-field takeoff where maximum climb rate is the goal even with both engines producing full power, operating at optimum angle of attack.

Disclosed embodiments are in particular illustrated with reference to twin engine aircraft. However, other designs of aircraft with three, four, or more engines, and with their thrust line not on the center of the aircraft, can have this same problem as a standard twin engine propeller driven aircraft with the engines on the wings. Disclosed embodiments are also useful with such aircraft designs. Further, in twin engine jet aircraft with the engines mounted on the Fuselage and no propellers, the loss of thrust and additional drag from an Engine loss is generally so minor that excess yaw is not a significant problem. However, disclosed embodiments can be used with such aircraft to ensure operation at the optimum angle of attack.

Some disclosed embodiments address the above-described problems experienced by twin engine propeller driven aircraft. However, excessive yaw can be a consideration in jet aircraft with the engines mounted on the wings. In many turbine-powered aircraft, an auto-feathering system is included due to the fact that the yaw can be extreme when an engine loses power, causing the aircraft to become uncontrollable without operational auto-feathering.

As discussed, disclosed embodiments can be implemented as a separate instrument display to maximize the pilot's situational awareness. This can also be beneficial in situations which could cause the system to activate in error and no loss of engine functionality has occurred. For example, in a crosswind landing with fully functioning engines, in order to not move sideways relative to the runway while on approach with a crosswind, an aircraft many times is intentionally put into a slip in order to align the wheels with the runway by slipping into the crosswind so that the aircraft is not moving sideways to the runway upon touchdown. This situation could potentially activate the instrument (as there is substantial yaw relative to the air the aircraft is moving through), but normally the pilot would know what is happening and just ignore the instrument. For such situations, a separate instrument from the primary artificial horizon instrument is useful to eliminate confusion so that it is obvious which system is being used to control the aircraft attitude, etc. If combined with the primary attitude instrument, and if the primary attitude instrument changes abruptly what it is indicating in scenarios such as crosswind landing, the pilot could be distracted. As in this situation it is important to continue operating the aircraft using information from the primary attitude instrument, having the disclosed engine failure maximum performance instrument be a separate instrument can provide further benefit in maximizing the pilot's situational awareness.

As discussed, some exemplary embodiments include one or more rudder deflection sensor 116 to indicate the direction and amount of rudder deflection. These sensors can be beneficial, and even necessary, because if the yaw is eliminated using the disclosed instrument 100, the instrument could assume the flight conditions are good, but in some exemplary embodiments the processing circuitry is configured such that if the rudder is deflected the instrument should continue to command rudder deflection until both the yaw is eliminated and the rudder is not deflected.

Although the present invention has been described by referring to preferred embodiments, workers skilled in the art will recognize that changes may be made in form and detail without departing from the spirit and scope of the invention.

What is claimed is:

1. An aviation instrument for use by a pilot of an aircraft in the event of loss or reduction of functionality of an engine of the aircraft, the aviation instrument comprising:
a display device; and
processing circuitry coupled to the display device and configured to control the display device to display a performance indication graphic which indicates to the pilot corrective action needed to control the aircraft to counteract adverse yaw motion caused by the event of loss or reduction of functionality of the engine of the aircraft.

2. The aviation instrument of claim 1, wherein the processing circuitry is further configured to control the display device to indicate to the pilot of the aircraft an optimum angle of attack for the aircraft, responsive to the event of loss or reduction of functionality of the engine of the aircraft.

3. The aviation instrument of claim 2, wherein the optimum angle of attack for the aircraft indicated by the display device is an angle of attack determined to provide a maximum climb or a minimum sink to optimize performance of the aircraft.

4. The aviation instrument of claim 1, wherein the processing circuitry is configured to automatically activate the aviation instrument upon sensing of excessive yaw motion of the aircraft.

5. The aviation instrument of claim 1, wherein the processing circuitry is configured to control the display device to display the performance indication graphic to indicate to the pilot which direction a rudder of the aircraft should be deflected to counteract the adverse yaw.

6. The aviation instrument of claim 5, wherein the processing circuitry is configured to control the display device to display the performance indication graphic to indicate to the pilot an amount of rudder deflection required to counteract the adverse yaw.

7. The aviation instrument of claim 6, wherein the performance indication graphic is a performance indication bar extending between left and right sides of the display device.

8. The aviation instrument of claim 7, wherein an orientation of the performance indication bar is indicative of an actual level horizon.

9. The aviation instrument of claim 7, and wherein the display device is controlled by the processing circuitry such that the performance indication bar includes a thicker portion on one of the left and right sides of the display relative to the other of the left and right sides of the display to indicate which direction the rudder of the aircraft should be deflected to counteract the adverse yaw.

10. The aviation instrument of claim 9, and wherein the display device is controlled by the processing circuitry such that a length of the thicker portion of the performance indication bar is indicative of the amount of rudder deflection required to counteract the adverse yaw.

11. The aviation instrument of claim 7, wherein the processing circuitry is further configured to control the display device to display an aircraft representation with the performance indication bar, and wherein the processing circuitry is configured to control the display device to display the aircraft representation and the performance indication bar such that an orientation of the performance indication bar relative to the aircraft representation indicates to the pilot a required bank angle of the aircraft in a direction of a non-failed engine.

12. The aviation instrument of claim 11, wherein the processing circuitry is further configured to control the display device to display an artificial horizon line relative to the aircraft representation and the performance indication bar.

13. The aviation instrument of claim 6, wherein the performance indication graphic includes a differential indication on one of the left and right sides of the display relative to the other of the left and right sides of the display to indicate which direction the rudder of the aircraft should be deflected to counteract the adverse yaw.

14. The aviation instrument of claim 13, wherein the differential indication includes a colored portion of a background which changes area proportional to an amount of additional rudder required.

15. The aviation instrument of claim 6, wherein the display device includes a left side indicator and a ride side indicator, and wherein the processing circuitry is configured to control the display device to illuminate one of the left-side indicator and the right-side indicator to indicate to the pilot which direction the rudder of the aircraft should be deflected to counteract the adverse yaw.

16. The aviation instrument of claim 6, wherein the processing circuitry is configured such that if the excessive yaw motion of the aircraft is determined to have been eliminated but the rudder is still deflected, the display device is controlled to indicate to the pilot to continue corrective action needed to control the aircraft until both the yaw is eliminated and the rudder is not deflected.

17. An aviation instrument for use by a pilot of an aircraft in the event of loss or reduction of functionality of an engine of the aircraft, the aircraft including a rudder controlled by left and right rudder pedals, the aircraft also including flaps controlled by a flap control device, the aviation instrument comprising:
a display device; and
processing circuitry coupled to the display device and configured to control the display device to display a performance indication graphic which indicates to the pilot corrective action needed to control the aircraft to counteract adverse yaw motion of the aircraft caused by the event of the loss or reduction of functionality of the engine, the corrective action indicated by the performance indication graphic including an indication of which of the left and right rudder pedals should be deflected to deflect the rudder and thereby counteract the adverse yaw motion of the aircraft, wherein the processing circuitry is further configured to control the display device to indicate to the pilot of the aircraft an optimum angle of attack for the aircraft, responsive to the event of loss or reduction of functionality of the engine of the aircraft.

18. The aviation instrument of claim 17, wherein the processing circuitry is further configured to control the display device to indicate to the pilot an optimum direction and angle of bank of the aircraft, responsive to the event of loss or reduction of functionality of the engine of the aircraft.

19. The aviation instrument of claim 17, wherein the processing circuitry is configured to identify an aircraft flap position based upon a flap position sensor output, and wherein the processing circuitry is further configured to modify the optimum angle of attack for the aircraft based upon the identified flap position.

20. The aviation instrument of claim 17, wherein the processing circuitry is further configured to control the display device to display an aircraft representation with the performance indication bar, and wherein the processing circuitry is configured to control the display device to display the aircraft representation and the performance indication bar such that an orientation of the performance indication bar relative to the aircraft representation indicates to the pilot a required bank angle of the aircraft in a direction of a non-failed engine.
